(19) United States
(12) Patent Application Publication
(10) Pub. No.: US 2005/0228927 A1
(43) Pub. Date: Oct. 13, 2005

(54) Bus utilization based on data transfers on the bus

(76) Inventor: Philip Garcia, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/818,404

(22) Filed: Apr. 5, 2004

(51) Int. Cl. G06F 13/00

(52) U.S. Cl. 710/305

(57) ABSTRACT

Techniques for bus utilization are disclosed. In an embodiment, the transfer signal, which indicates the period during which data is transferred on a bus, is calculated, and, based on this transfer signal, the number of data transfers per time unit is determined. The duty cycle of the transfer signal is also used to determine bus utilization. Further, the bus utilization is used to arbitrate buses, to balance bus load, etc.

### FIELD OF THE INVENTION

The present invention relates to bus utilization in computer systems.

### BACKGROUND OF THE INVENTION

Determining bus utilization in computer systems provides useful information for various purposes. However, current approaches for such determination are generally involved with complicated software and/or hardware. For example, many approaches include complex state machines and/or logic analyzer functionality to decode activities occurring on the bus, to keep track of the flow of data activities, to measure performance of the devices that use the bus, etc. Further, various current mechanisms that arbitrate buses generally use fixed algorithms that are inflexible and may cause load imbalance, e.g., heavy traffic on a bus while leaving other buses idle. For example, in a “fixed order” mechanism, devices are granted a bus based on a predefined order, e.g., a first device, a second device, a third device, etc. However, this mechanism causes load imbalance if the number of data transfers for each device is unequal each time the device is granted the bus.

### SUMMARY OF THE INVENTION

The present invention relates to bus utilization. In an embodiment, the transfer signal, which indicates the period during which data is transferred on a bus, is calculated, and, based on this transfer signal, the number of data transfers per time unit is determined. The duty cycle of the transfer signal is also used to determine bus utilization. Further, the bus utilization is used to arbitrate buses, to balance bus load, etc.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows a system upon which embodiments of the invention may be implemented;

FIG. 2 shows timing diagrams for illustration of providing bus utilization based on the number of data transfers, in accordance with an embodiment;

FIG. 3 shows timing diagrams to illustrate the generation of signals representing the number of data transfers for devices on a multiple-device bus, in accordance with an embodiment;

FIG. 4 shows an RC network that may be used to generate the DC component of the transfer signal, in accordance with an embodiment.

FIG. 5 shows diagrams to illustrate bus utilization based on the duty cycle of the transfer signals; and

FIG. 6 shows a diagram of an exemplary computer system.

### DETAILED DESCRIPTION OF VARIOUS EMBODIMENTS

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### Overview

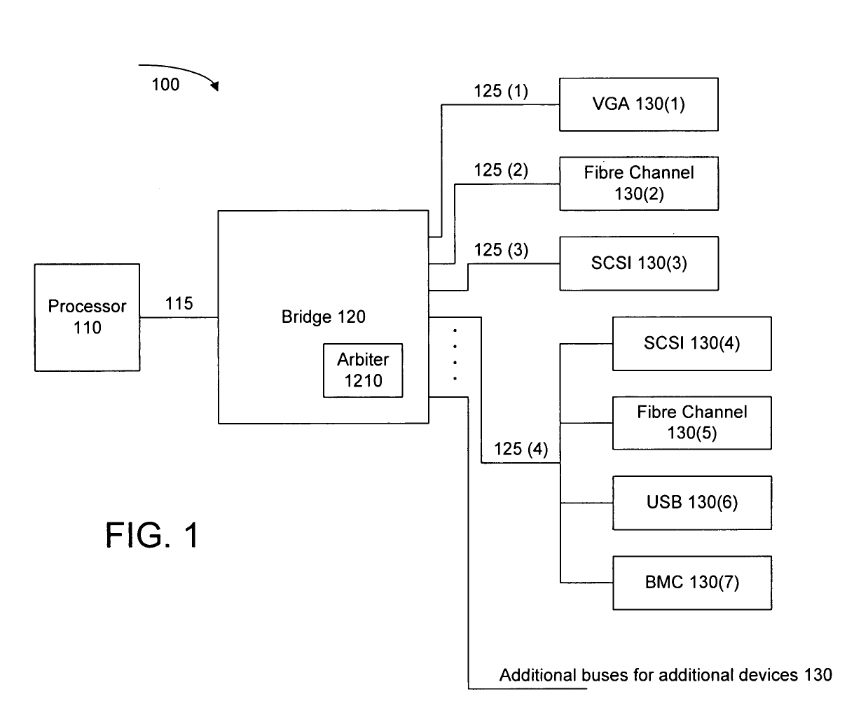

FIG. 1 shows a system 100 that includes a processor 110, a bridge 120, and a plurality of devices 130, upon which embodiments of the invention may be implemented. System 100 may be implemented on a chip, part of a chip set, part of a computer system, etc.

Processor 110, commonly found in computer systems, interfaces with bridge 120 via processor bus 115.

A device 130 may be any one of the devices that utilize a bus, such as a VGA (Video Graphic Array) card, a fibre channel device, a SCSI (Small Computer System Interface) device, a USB (Universal Serial Bus) device, etc.

Bridge 120 bridges different kinds of bus one side to other kinds of bus on the other side, including, for example, buses 115 and 125. Depending on situations, bridge 120 may use one bus to communicate with one or a plurality of devices 130. In the example of FIG. 1, bridge 120 uses buses 125(1), 125(2), and 125(3) to communicate with a VGA card 130(1), a fibre channel device 130(2) and a SCSI device 130(3), respectively. Further, bridge 120 uses bus 125(4) to communicate with a SCSI device 130(4), a fibre channel device 130(5), a USB device 130(6), and a BMC (Baseboard Management Controller) 130(7). Bridge 120 may act on behalf of processor 110 to initiate data transfer from and to devices 130 and/or between devices 130. In an embodiment, bridge 120 includes an arbiter 1210 to arbitrate buses. FIG. 1 shows one bridge 120 for illustration purposes. However, depending on implementation, there may be more than one bridge 120.

Buses, e.g., 115 and 125, are means for data to be transferred between devices, other components of system 100 and/or computer systems embodying system 100. Examples of these buses include PCI (Peripheral Component Interconnect), PCI-X (enhanced PCI), ISA (Industry Standard Architecture), ISA expansion, I²C (Inter-IC) etc. However, embodiments of the invention are not limited to these buses, but are applicable to other buses as well. Devices may be coupled at different locations of a bus.

### Bus Utilization Based on the Number of Data Transfers

In various embodiments, bus utilization is determined based on the number of data transfers and/or the number of data transfers per time unit, e.g., micro-second, second, minute, etc. In an embodiment, each data transfer occurs at the rising edge of a bus clock and the signal representing the transfer period is active high and logically AND with the bus clock signal to provide the number of data transfers. Having the transfer time and the number of data transfers during that time, the number of data transfers per time unit is calculated using various techniques involving one or a combination of hardware and software of a counter and timer, a logic circuit, a processor, etc. For example, a timer times the start of the transfer period(s) while a counter counts the number of pulses during that time period(s), etc. The invention is not limited to a particular piece of hardware or software or combinations thereof in calculating the number of transfer per time unit. Embodiments of the invention also use BMC 130(7) to provide the number of data transfers per time unit as explained below.

Depending on situations including the type of buses, the transfer period is calculated based on the signal “ready” of the devices involved in the data transfer, the handshake signals preparing for the transfer to start, etc. For example, in PCI bus devices, the device that desires the data transfer, commonly referred to as the initiator device, initiates an “initiator ready signal,” e.g., signal IRDY. In response, the target device, when ready, asserts a “target ready signal,” e.g., signal TRDY. As a result, the transfer period is the period when both the initiator ready signal IRDY and the target ready signal TRDY are asserted. Alternatively, for ISA bus devices, which use only one ready signal, e.g., signal RDY, the transfer period is the period when this RDY signal is asserted.

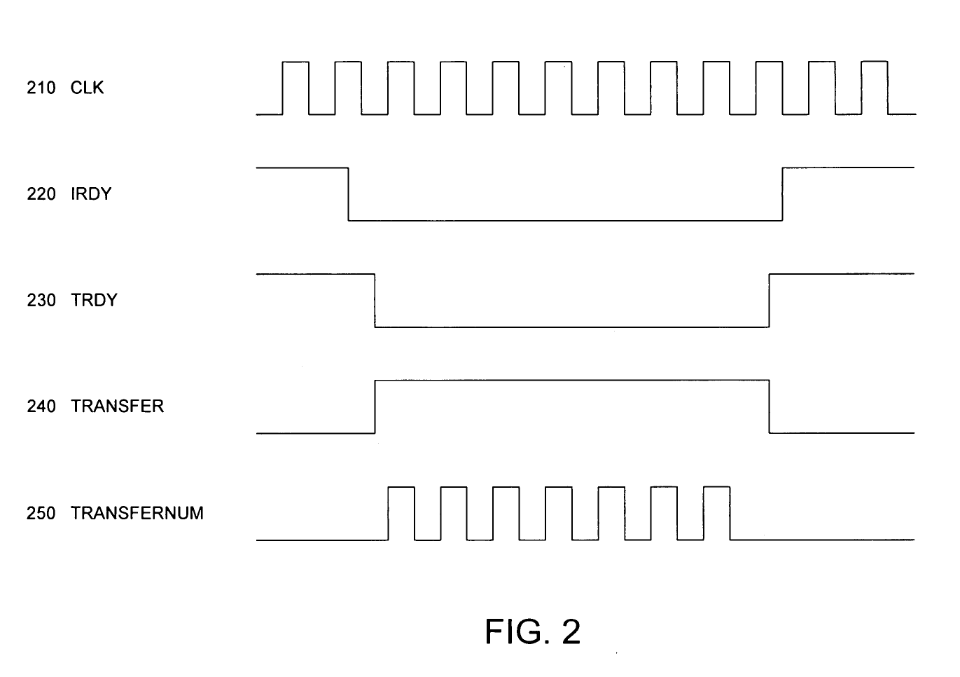

FIG. 2 shows timing diagrams for illustration of providing bus utilization based on the number of data transfers. For illustration purposes, the data is transferred on PCI bus 125(1) between bridge 120 and VGA device 130(1).

Line 210 shows the bus clock signal CLK that is normally used in system 100, and, for illustration purposes, a data transfer occurs at the rising edge of signal CLK.

Line 220 shows an “initiator” ready signal IRDY asserted by bridge 120 to indicate that bridge 120 is ready for such transfer. In this example, signal IRDY is asserted low.

Line 230 shows a “target” ready signal TRDY asserted by the target VGA device 130(1) to indicate that VGA device 130(1) is ready for the data transfer. In this example, signal TRDY is asserted low.

Line 240 shows a signal TRANSFER indicating the time during which data is transferred, e.g., between bridge 120 and VGA device 130(1). For illustration purposes, signal TRANSFER is active high, and, in an embodiment, is generated from a NOR gate having signals IRDY and TRDY as inputs.

Line 250 shows a signal TRANSFERNUM indicating individual data transfers during the time period when signal TRANSFER is asserted. In this example, signal TRANSFERNUM is generated from an AND gate having signals TRANSFER and CLK as inputs. Further, there are seven pulses in signal TRANSFERNUM, and thus there are seven transfers during the time period TRANSFER.

In an embodiment, on multiple device bus, e.g., bus 125(4), which is coupled to more than one device, the transfer period represented by signal TRANSFER and the number of data transfer represented by signal TRANSFERNUM apply to all devices on the bus, e.g., devices 130(4), 130(5), 130(6), and 130(7) for bus 125(4). However, the TRANSFERNUM signal for each device on that multiple-device bus may be generated.

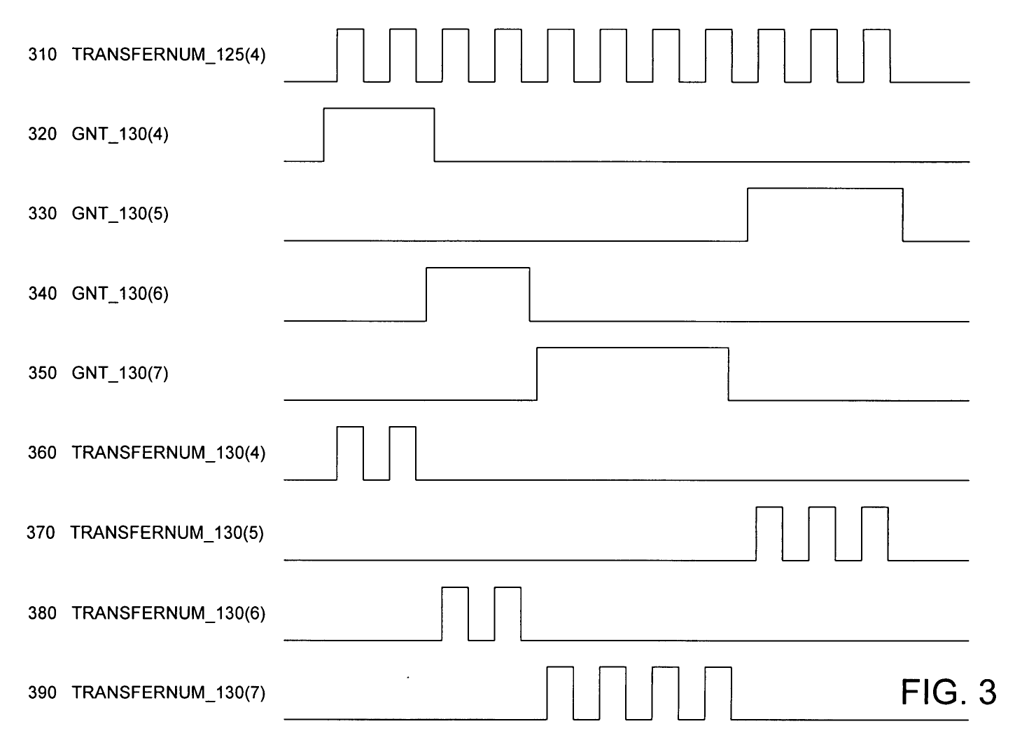

FIG. 3 shows signals to illustrate how the individual TRANSFERNUM signal is generated for four devices 130(4), 130(5), 130(6), and 130(7) for bus 125(4). For illustration purposes, devices 130(4), 130(5), 130(6), and 130(7) are associated with four “grant” signals GNT_130(4), GNT_130(5), GNT_130(6), and GNT_130(7), respectively. That is, when signal GNT_130(4) is asserted, the data for device 130(4) is being transferred; when signal GNT_130(5) is asserted, the data for device 130(5) is being transferred; and when signal GNT_130(6) is asserted, the data for device 130(6) is being transferred, etc. For illustration purposes, the grant signals in FIG. 3 are asserted high.

Line 310 shows signal TRANSFERNUM_125(4) representing the number of data transfers for bus 125(4). Signal TRANSFERNUM_125(4) may be generated as illustrated in FIG. 2, and, as shown in FIG. 3, includes eleven pulses for a total of eleven transfers among the four devices 130(4), 130(5), 130(6), and 130(7).

Lines 320, 330, 340, 350 show the exemplary grant signals GNT_130(4), GNT_130(5), GNT_130(6), and GNT_130(7), respectively.

Lines 360, 370, 380, and 390 show signals TRANSFERNUM_130(4), TRANSFERNUM_130(5), TRANSFERNUM_130(6), and TRANSFERNUM_130(7) associated with devices 130(4), 130(5), 130(6), and 130(7), respectively. In this example, signals TRANSFERNUM_130(4), TRANSFERNUM_130(5), TRANSFERNUM_130(6), and TRANSFERNUM_130(7) are each generated from an AND gate having signals TRANSFERNUM_125(4) and either GNT_130(4), GNT_130(5), GNT_130(6), or GNT_130(7) respectively as inputs. As illustrated, signals TRANSFERNUM_130(4), TRANSFERNUM_130(5), TRANSFERNUM_130(6), and TRANSFERNUM_130(7) include two, three, two, and four pulses, respectively, for a total of eleven pulses or transfers, which is the number of pulses or transfers shown in signal TRANSFERNUM_125(4).

In the above examples of FIG. 2 and 3, the logic gates NOR and AND are used, and they may be located at any convenient location, including on the appropriate bus 125. However, in accordance with techniques of the invention, other logic gates or devices may be used in place of the NOR gate and AND gate to generate signals TRANSFER, TRANSFERNUM, TRANSFERNUM_130, etc. The type of the logic gate is selected dependent on the logic level of the input and/or output of the logic gates. For example, if only one ready signal RDY that is active low is used, then signal TRANSFER may be generated from the signal RDY by using an INVERTER. However, if signal RDY is active high, then signal TRANSFERNUM may be generated directly from signal RDY being AND'ed with the clock signal CLK, etc.

Further, the above description relates to embodiments of the invention. However, the invention is not limited to the location of the logic gate, a particular type of bus, the number of ready signals, whether these ready signals are asserted high or low, whether the data transfer occurs at the falling or rising edge of the clock signal, whether a signal is asserted high or low, etc. Additionally, any intelligent element, e.g., a device, a bridge, a processor, may act as an initiator or a target.

### The Baseboard Management Controller 130(7)

In an embodiment, BMC 130(7) is a service processor providing services for system 100 and/or other systems embodying system 100. Typically, BMC 130(7) includes its own processing elements, memory, firmware code, etc. BMC 130(7) facilitates functions such as remote console access, event and error logging, etc. BMC 130(7) controls the system hardware, facilitates and controls manageability services, including, for example, system diagnostics, environmental monitoring, information passing to externally-connected system administrators, etc. BMC 130(7) also provides an interface port for external console access, which enables remote, out-of-band system administration of system 100. As a result, a system administrator may perform system administration without utilizing the system hardware and/or operating system resources. Examples of system administration include redirecting the console, observing the boot process, viewing and/or modifying basic I/O system (BIOS) setup parameters, responding to system management messages, viewing sensor data, alarms, thresholds, FRU data, BMC's configuration, password, data, etc. BMC 130(7) also monitors the health of system 100, the temperatures of different components such as processor 110, the chassis of the computer embodying system 100, etc. BMC 130(7) stores information that can be used by processor 110, including, for example, temperature of the chassis, temperature of the processor, information on NVRAM (non-volatile Random Access Memory), mechanism indicating whether the chassis has been open, etc.

In an embodiment, BMC 130(7) includes an input for a fan tachometer to measure how fast a fan is running. If the temperature starts getting too high, then BMC 130(7) reports the information to processor 110 for it to take appropriate actions, such as increasing the power to the fan for it to spin faster and thus reduce the temperature. Each pulse represents a revolution of the fan, and BMC 130(7) determines the number of pulses or the number of revolutions per minute (RPM). However, in an embodiment, signal TRANSFERNUM is fed into the input for the fan tachometer. As a result, BMC 130(7), instead of measuring the revolution per minute for the fan, measures the number of data transfers per minute for a bus, such as a bus 125. In effect, BMC 130(7) calculates the bus utilization based on the number of data transfers per minute.

FIG. 1 shows that BMC 130(7) is on a multiple-device bus, e.g., bus 125(4). BMC 130(7) may be on a single-device bus, such as a bus 125(1), 125(2), 125(3), etc., and the bus type may vary as appropriate, and include, for example, PCI bus, I²C bus, etc. BMC 130(7) may also be directly coupled to bridge 120, coupled to bridge 120 via a hardware interface, etc. The invention is not limited to how BMC 130(7) is connected to a system.

### Using Bus Utilization Based on the Number of Data Transfers For Various Purpose Including Bus Arbitration

In various embodiments, the number of data transfers on the buses is used in arbitrating buses, by itself or in conjunction with other approaches. In an embodiment, arbiter 1210 having information about the number of data transfers in a period and/or the number of data transfers per time unit can make appropriate decisions including determining which and/or when a device may have a bus, how long that device may have the bus for, etc. Depending on implementations, arbiter 1210 may include one or various layers for arbitrating subordinate buses, such as when a subordinate bus (not shown) seeks access to a parent bus, e.g., bus 125(4). The invention is not limited to the architecture of arbiter 1210. Arbiter 1210's decisions may be made in conjunction with the desired goals such as balancing the data traffic between the buses, allowing devices to have enough time on the bus to transfer data, providing priority for granting a bus, etc. For example, arbiter 1210 may decide that, at a particular period of time, all devices should have equal bandwidth or a certain percentage of the bandwidth on the bus. At another time, some devices may have higher priority and thus more bandwidth percentage on the bus, such as a first device VGA 130(1) to have 50% of the bandwidth, a second device Fibre Channel 130(2) to have 30% of the bandwidth, and a third device SCSI 130(3) to have 20% of the bandwidth, etc. Arbiter 1210 is configured with appropriate logic circuits and/or firmware/software so that it can make decisions dynamically or “on the fly” to allocate the bus to appropriate devices. An intelligent processing element such processor 110, BMC 130(7), etc., via one or a combination of hardware, software and firmware may drive arbiter 1210 or work with arbiter 1210 to implement the desired bus arbitration goals. Generally, arbiter 1210 uses a “request” and “grant” scheme in which the devices that desire to have the bus provide a request signal REQ to arbiter 1210, which, when ready to grant the bus to a device, provides a grant signal GNT to that device.

In one aspect, the bandwidth granted to each bus may be controlled, e.g., to solve load-imbalance/bottleneck problems, to allow some devices to have some predetermined bandwidth accessing a bus, rather than that device taking most of the time and prevent other devices from having the bus, etc. In FIG. 1, arbiter 1210 is in bridge 120, but it could reside in any other convenient location including outside of bridge 120.

Examples of bus arbitration approaches that arbiter 1210 may use in conjunction with techniques of the invention include: ownership, fixed priority, fixed order, last granted, round robins, least-recently requested, etc. However, the invention is not limited to these approaches; other approaches are applicable as well. As an example, following is an illustration of how the number of data transfers is used in conjunction with the “ownership” rule wherein the number of data transfers per ownership and the number of times a device owns a bus are inputs to arbiter 1210 for determining whether to grant a bus to a device. For illustration purposes, arbiter 1210 determines that, on the average, each device should be allocated the same amount of bandwidth transferring data, and two devices VGA 130(1) and SCSI 130(3) are considered in a bus arbitration. However, each time VGA device 130(1) is granted or “owns” the bus, it transfers one byte of data while, each time SCSI device 130(3) is granted the bus, it transfers 100 bytes of data. Arbiter 1210, based on the number of data transfers per time unit (i.e., bandwidth), allows VGA device 130(1) to own the bus 100 times before allowing SCSI device 130(3) to own the bus one time. In effect, bus utilization is about equal or 50% for each of the two devices 130(1) and 130(3) because VGA device 130(1), while owning the bus 100 times, transfers 100 bytes of data, and SCSI device 130(3), while owning the bus one time, also transfer 100 bytes of data. In this example, depending on the desired results, arbiter 1210 may adjust the number of ownerships based on the number of data transfers per time unit. For example, if arbiter 1210 determines that VGA device 130(1) should have the bus ⅓ of the time and SCSI device 130(3) should have the bus ⅔ of the time, then arbiter 1210 allows device 130(1) to own the bus 50 times before allowing SCSI device 130(3) to own the bus one time. In effect, VGA device 130(1) would transfer 50 bytes while SCSI device 130(3) would transfer 100 bytes. Alternatively, if arbiter 1210 recognizes that, at some time period, VGA device 130(1) would transfer ten bytes of data per ownership based on the average bandwidth (the number of transfers per time unit), then during that period, arbiter 1210 would allow VGA device 130(1) to own the bus ten times before granting the bus to SCSI device 130(3), etc. As can be seen, various combinations of bandwidth and the number of ownerships may be realized depending on the desired results, arbiter 1210 may be programmed to make decisions on the fly based on the number of data transferred, and the invention is not limited to a particular combination. Further, the above example uses two devices 130(1) and 130(3) for illustration purposes only, more than two devices may be considered by arbiter 1210 in a bus arbitration scheme in conjunction with the above-described technique. Those skilled in the art will recognize that without considering the number of data transfers per ownership for the same number of ownerships among the devices, SCSI device 130(3) would own the bus longer and thus transfer much more data than VGA device 130(1). For example, for the same number of three ownerships, VGA device 130(1) would transfer three bytes of data while SCSI device 130(3) would transfer 300 bytes of data.

Bus utilizations in terms of the number of data transfers in accordance with techniques of the invention may also be provided to an intelligent processing element such as processor 110, BMC 130(7), among others, to be used as appropriate. For example, BMC 130(7), via its firmware, can program or configure arbiter 1210 on the fly to make appropriate decisions as described above. Alternatively, processor 110, BMC 130(7), bridge 120, rather than arbiter 1210, may statistically use the number of data transfers per time unit on each bus to load balance the bus. Similarly, a system engineer may use the bus utilization information to reconfigure the system, including system 100, to redirect crowded traffic on a first bus to a second bus, etc. As implementations and to control arbiter 1210, a hardware interface may be provided between arbiter 1210 and BMC 130(7) or the element that generates a measure of data transfers per time unit. Alternatively, software running on processor 110 and/or firmware of BMC 130(7) generates the number of data transfers per time unit and provides the signals to control arbiter 1210, etc.

### Bus Utilization Based on the Duty Cycle of the Signal Representing the Transfer Periods

In various embodiments, the duty cycle of the transfer signal (e.g., signal TRANSFER in FIG. 2) representing the transfer periods on a bus may be used to determine bus utilization of such bus because this duty cycle is approximately equal to the percentage of time that that bus is actively transferring data. In an embodiment, the transfer signal is filtered through an RC network that provides the DC voltage component proportional to the duty cycle. This DC voltage is then fed into an ADC (analog-to-digital converter) input of BMC 130(7) so that BMC 130(7), via its firmware, can directly read the magnitude of the input voltage. BMC 130(7) then divides this voltage measurement by the full-scale amplitude of the transfer signal to provide a quotient that is approximately equal to the duty cycle of the signal, which, as explained above, is approximately equal to the percentage of time the bus is transferring data. Additionally, in various embodiments, the duty cycle of various transfer signals associated with various buses may be compared against one another to compare the bus utilization among those buses. Like the bus utilization based on the number of data transfers, bus utilization based on the duty cycle of the transfer signal may be used by various processing elements for various purposes similar to those described above.

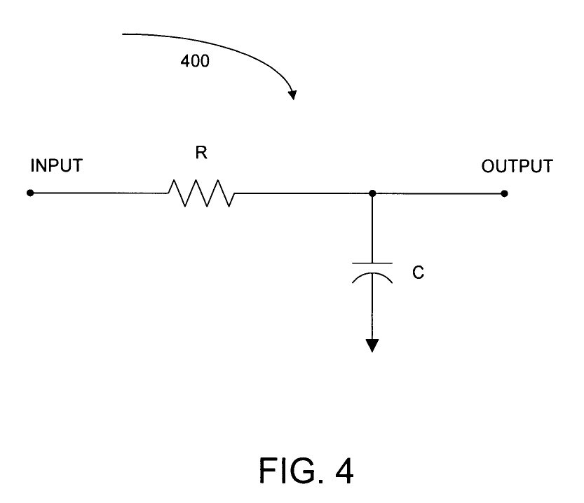

FIG. 4 shows an RC network 400 that may be used to generate the DC component of the transfer signal, in accordance with an embodiment.

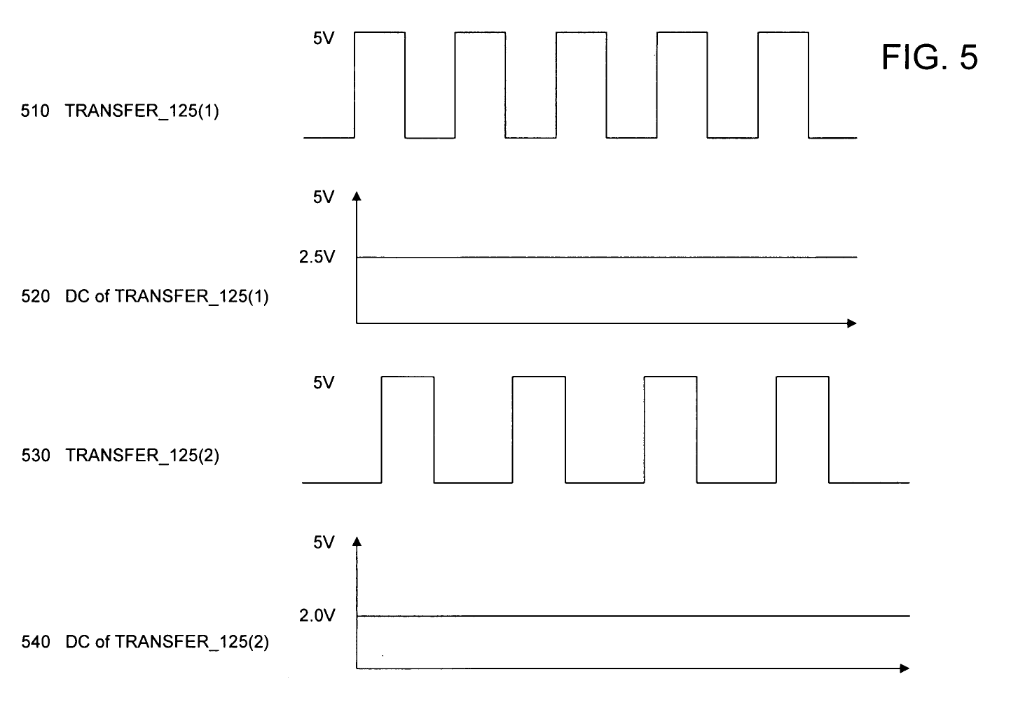

FIG. 5 shows diagrams illustrating bus utilization based on the duty cycle of signals TRANSFER_125(l) and TRANSFER_125(2) representing the transfer periods on buses 125(1) and 125(2), respectively, in accordance with an embodiment. For illustration purposes, the amplitude of both signals TRANSFER_125(1) and TRANSFER_125(1) is 0-5V. Line 510 shows signal TRANSFER_125(1) having a duty cycle of 50%. Line 520 shows the DC component of signal TRANSFER_125(1) resulted from being fed to the RC network 400. Because the duty cycle of signal TRANSFER_125(1) is 50%, the DC component is at 50% of the amplitude of signal TRANSFER_125(1), which is 2.5V. Line 530 shows signal TRANSFER_125(2) for bus 125(2) with a duty cycle of 40%. Line 520 shows the DC component of signal TRANSFER_125(2) being fed through RC network 400. Because the duty cycle of signal TRANSFER_125(2) is 40%, the DC component is at 40% of the amplitude of signal TRANSFER_125(1), which is 2.0V.

### Computer System Overview

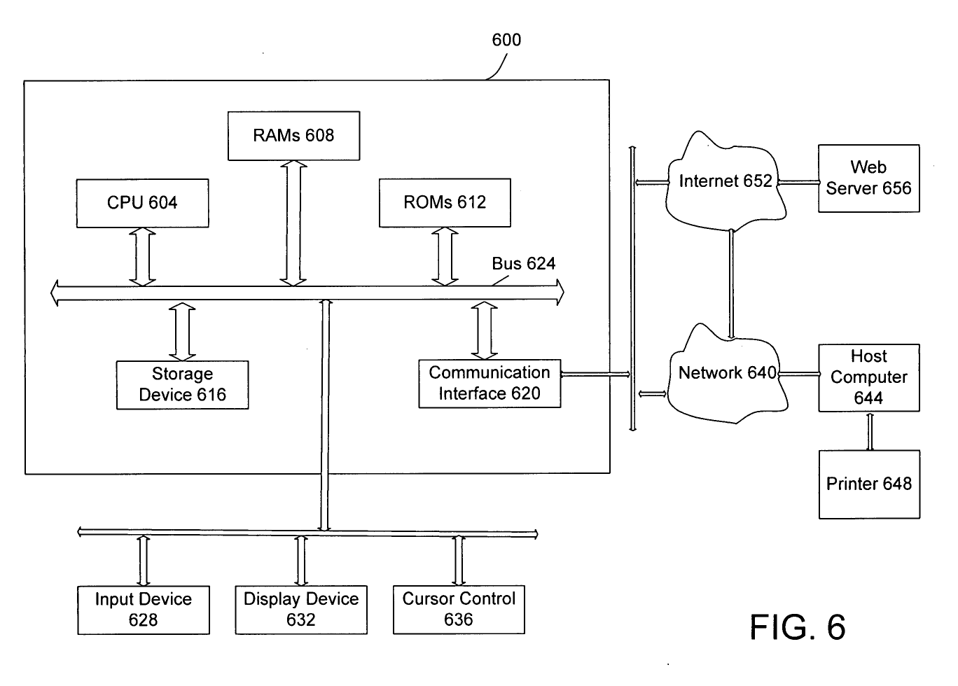

FIG. 6 is a block diagram showing a computer system 600 upon which embodiments of the invention may be implemented. For example, computer system 600 may be implemented to operate as system 100, to include system 100, to run arbiter 1210, to perform tasks in accordance with the techniques described above, etc. In an embodiment, computer system 600 includes a central processing unit (CPU) 604, random access memories (RAMs) 608, read-only memories (ROMs) 612, a storage device 616, and a communication interface 620, all of which are connected to a bus 624.

CPU 604 controls logic, processes information, and coordinates activities within computer system 600. In an embodiment, CPU 604 executes instructions stored in RAMs 608 and ROMs 612, by, for example, coordinating the movement of data from input device 628 to display device 632. CPU 604 may include one or a plurality of processors.

RAMs 608, usually being referred to as main memory, temporarily store information and instructions to be executed by CPU 604. Information in RAMs 608 may be obtained from input device 628 or generated by CPU 604 as part of the algorithmic processes required by the instructions that are executed by CPU 604.

ROMs 612 store information and instructions that, once written in a ROM chip, are read-only and are not modified or removed. In an embodiment, ROMs 612 store commands for configurations and initial operations of computer system 600.

Storage device 616, such as floppy disks, disk drives, or tape drives, durably stores information for use by computer system 600.

Communication interface 620 enables computer system 600 to interface with other computers or devices. Communication interface 620 may be, for example, a modem, an integrated services digital network (ISDN) card, a local area network (LAN) port, etc.

Those skilled in the art will recognize that modems or ISDN cards provide data communications via telephone lines while a LAN port provides data communications via a LAN. Communication interface 620 may also allow wireless communications.

Bus 624 can be any communication mechanism for communicating information for use by computer system 600. In the example of FIG. 6, bus 624 is a media for transferring data between CPU 604, RAMs 608, ROMs 612, storage device 616, communication interface 620, etc.

Computer system 600 is typically coupled to an input device 628, a display device 632, and a cursor control 636. Input device 628, such as a keyboard including alphanumeric and other keys, communicates information and commands to CPU 604. Display device 632, such as a cathode ray tube (CRT), displays information to users of computer system 600. Cursor control 636, such as a mouse, a trackball, or cursor direction keys, communicates direction information and commands to CPU 604 and controls cursor movement on display device 632.

Computer system 600 may communicate with other computers or devices through one or more networks. For example, computer system 600, using communication interface 620, communicates through a network 640 to another computer 644 connected to a printer 648, or through the world wide web 652 to a server 656. The world wide web 652 is commonly referred to as the “Internet.” Alternatively, computer system 600 may access the Internet 652 via network 640.

Computer system 600 may be used to implement the techniques described above. In various embodiments, CPU 604 performs the steps of the techniques by executing instructions brought to RAMs 608. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 604 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-RAM, a CD-RAM, a DVD-ROM, a DVD-RAM, or any other optical medium, paper-tape, punch-card, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 604 are in the form of one or more software programs and are initially stored in a CD-ROM being interfaced with computer system 600 via bus 624. Computer system 600 loads these instructions in RAMs 608, executes some instructions, and sends some instructions via communication interface 620, a modem, and a telephone line to a network, e.g. network 640, the Internet 652, etc. A remote computer, receiving data through a network cable, executes the received instructions and sends the data to computer system 600 to be stored in storage device 616.

In the foregoing specification, the invention has been described with reference to specific embodiments thereof However, it will be evident that various modifications and changes may be made thereto without departing from the broader spirit and scope of the invention. Accordingly, the specification and drawings are to be regarded as illustrative rather than as restrictive.

1. A method for determining bus utilization, comprising:
using a first signal to indicate a time period in which devices connected to a bus are ready for data to be transferred; and
using the first signal and a clock signal to generate a second signal representing the number of data transfers in the time period; an
edge of the clock signal indicating occurrence of a data transfer.

2. The method of claim 1 wherein the first signal being derived from a third signal that indicates that at least two devices are ready for the data to be transferred.

3. The method of claim 1 wherein the first signal being derived from a third signal and a fourth signal; the third signal and the fourth signal indicating that at least a first device and second device are ready for the data to be transferred.

4. The method of claim 1 wherein a management controller uses the second signal to provide at least one of the number of data transfers and the number of data transfers per time unit.

5. The method of claim 4 wherein the second signal is fed into the fan-tachometer input of the management controller.

6. The method of claim 1 wherein the second signal being used in arbitrating buses.

7. The method of claim 1 wherein at least one of the number of data transfers in the time period and a number of data transfers per time unit being used in arbitrating buses in conjunction with at least one of the following techniques: ownership, fixed order, priority order, last granted, round robins, least-recently requested.

8. The method of claim 1 wherein at least one of the number of data transfers in the time period and a number of data transfers per time unit is used in controlling a bandwidth of the bus.

9. The method of claim 1 wherein a duty cycle of the first signal being used to represent utilization of the bus.

10. The method of claim 1 wherein a duty cycle of the first signal and a duty cycle of a third signal are used to determine utilization of the bus and of another bus associated with the third signal.

11. The method of claim 1 wherein the second signal represents the numbers of transfers in the time period for more than one device connected to the bus.

12. A system comprising:
an initiator device for generating an initiator ready signal;
a target device for generating a target ready signal;
means for generating a first signal representing a time period during which data is actively transferred on a bus that couples the initiator device and the target device; and
means for generating a second signal representing a number of data transfers in between the time period.

13. The system of claim 12 wherein the initiator device and the target device are selected in at least a processor, a bridge, a management controller, and a device utilizing the bus.

14. The system of claim 13 wherein the bus is selected from a group consisting of a PCI bus, an enhanced PCI bus, an ISA bus, an ISA expansion bus, and an I²C bus.

15. The system of claim 12 wherein the second signal is generated from the first signal and a bus clock via a logic device.

16. The system of claim 15 further comprises a management controller for providing a number of data transfers per time unit based on the second signal.

17. The system of claim 16 wherein the second signal is fed into a fan-tachometer input of the management controller to provide the number of data transfers per time unit.

18. The system of claim 12 wherein the second signal and information derived from the second signal are used in at least one of arbitrating and load balancing buses.

19. The system of claim 12 wherein a duty cycle of the first signal is used in at least one of arbitrating and load balancing buses.

20. A system comprising:
a first logic device for generating a first signal representing a time period during which data is being transferred on a bus; and
a second logic device for generating a second signal from the first signal and a bus clock; the second signal representing a number of data transfers during the time period; a data transfer occurs at an edge of the bus clock.

21. The system of claim 20 wherein at least one first device being coupled at a first location of the bus and at least one second device being coupled at a second location of the bus.

22. The system of claim 20 further comprises:
a bridge for bridging different kinds of buses; and
a bus arbiter for arbitrating the buses.

23. The system of claim 22 further comprises a management controller for performing at least one of the following tasks:
providing information to the bus arbiter in arbitrating the buses; the information being derived from the second signal;
using the second signal and information derived from the second signal to balance bus loads;
determining bus utilization of the bus based on a duty cycle of the first signal;
determining bus utilization of the bus based on a measurement of the second signal; and
working with a processor to balance the bus loads.

24. The system of claim 20 further comprises means for providing bus utilization based on a duty cycle of the first signal.

25. The system of claim 20 where in the first signal being generated by a method selected from a group consisting of:
using a ready signal indicating all devices on the bus are ready for the data to be transferred; and
using an initiator ready signal indicating an initiator device is ready for the data to be transferred and a target ready signal indicating a target device is ready for the data to be transferred; the initiator device and the target device are coupled to the bus.
